(19) United States
(12) Patent Application Publication
(10) Pub. No.: US 2014/0017466 A1
(43) Pub. Date: Jan. 16, 2014

(54) DOUBLE-SIDED ADHESIVE TAPE HAVING IMPROVED REWORKABILITY

(71) Applicant: Jong-Seob Won, Gyeonggi-do (KR)

(72) Inventor: Jong-Seob Won, Gyeonggi-do (KR)

(73) Assignee: 3M INNOVATIVE PROPERTIES COMPANY, St.Paul, MN (US)

(21) Appl. No.: 13/991,238

(22) PCT Filed: Dec. 28, 2011
(86) PCT No.: PCT/US11/67537

§ 371 Date: Sep. 16, 2013

(30) Foreign Application Priority Data
Dec. 31, 2010 (KR) 10-2010-0139930
Aug. 11, 2011 (KR) 10-2011-0080093

(51) Int. Cl. B32B 7/06; B32B 7/12; B32B 7/02; C09J 7/02

(52) U.S. Cl. CPC B32B 7/06; C09J 7/0264; C09J 7/0285; B32B 7/12; B32B 7/02
USPC 428/214; 428/354; 428/217; 428/337

(57) ABSTRACT

The present invention relates to a double-sided adhesive tape, which is easily peeled off by force applied to an adhered surface in a parallel direction thereby providing excellent reworkability. The present invention provides a double-sided adhesive tape, in which one of layers of an adhesive sheet formed of multiple layers can be easily peeled off and removed.

### TECHNICAL FIELD

The present invention relates to a double-sided adhesive tape having improved reworkability. In particular, the present invention relates to a double-sided adhesive tape in which when force is applied to an adhered surface in a parallel direction, one of the layers of the double-sided adhesive tape formed of multiple layers is easily peeled off, thereby improving reworkability in a process of manufacturing a product using the double-sided adhesive tape.

### BACKGROUND

In a process for manufacturing products such as electronic devices, various types of adhesives or adhesive tapes are used. In the case where a defect occurs in the process of manufacturing the products, the products may be discarded or disassembled to separate components, and the disassembled components are reused.

As electronic devices have recently been developed to meet higher performance and quality standards, each configuration of the components of electronic devices also has been developed to meet these higher performance and quality standards, and thus has become expensive. Under the circumstances, in the case where a defect occurs in a process of manufacturing an electronic product, if the product is discarded economic loss will be serious in addition to resource consumption and environmental contamination.

One example for the high cost configuration components of an electronic device is a touch panel. A touch panel is a device mounted on a surface of a display panel to convert physical contact by a finger of a user, a touch pen, or other stylus into an electrical signal and output the signal. The touch panel has been applied to liquid crystal displays, plasma display panels, EL (electro-luminescence) devices, and organic light emitting diodes, etc.

The touch panel has a complex configuration and is expensive. However, during a process of attaching the touch panel onto a display panel or attaching a cover window for protection onto a touch screen, defects may occur. The defects may be caused by contamination by dust or by a positioning error during the attachment process. In case of such defects, if the defective product is discarded, monetary losses will occur. In order to reduce the economic damage, it would be desirable to separate the touch panel from the display panel or from the cover window and reuse the touch panel. The benefit of reuse is required for other components as well as the touch panel.

However, since the touch panel is firmly adhered to the display panel or the cover window as a counterpart in the process of manufacturing the product, the touch panel may not be easily separated or may be damaged in the separation process. If the touch panel is not separated or is damaged during the separation process, the high-priced touch panel, which has no problem in performance, could not be reused. Even if the touch panel is separated without causing any damage, if residues of an adhesive exist on the separated touch panel, it would be difficult to reuse the separated touch penal.

At the present time, electronic devices and their configuration components are complex and highly expensive. In view of manufacturing cost reduction and workability, it is desired that, even if a defect occurs in a process of manufacturing an electronic device, individual components of the electronic device can be reused in a safe manner for reworking.

### SUMMARY

It is an object of the present invention to provide an adhesive tape which is capable of safely attaching electronic device components to one another and, if necessary, can be easily peeled off, thereby improving reworkability.

It is another object of the present invention to provide an adhesive tape in which a particular layer of the adhesive tape formed of multiple layers is easily peeled off so that even if a defect occurs in a process of assembling components using the adhesive tape, the components can be easily separated.

It is still another object of the present invention to provide a display device manufactured by using the adhesive tape.

The present invention provides a double-sided adhesive tape including a film-shaped sheet, a first adhesive layer disposed on one surface of the sheet, and a second adhesive layer disposed on the other surface of the sheet.

In the double-sided adhesive tape, shear strength of the second adhesive layer is in a range of about 0.05 kg/in² to about 16 kg/in² under the condition that the temperature is 60° C., an aluminum strip is attached to a SUS panel by using the double-sided adhesive tape, and the cross-head speed to peel off the aluminum strip from the SUS panel is 10 mm/min. While opposing force is applied between the aluminum strip and the SUS panel in a parallel direction, stress and strain are measured and the maximum stress is regarded as shear strength (refer to FIGS. 7 and 8). For reference, the SUS panel is a stainless steel panel.

If the shear strength of the second adhesive layer is smaller than about 0.05 kg/in², the second adhesive layer may be peeled off due to impact or other causes during ordinary use thereby causing inconvenience in use. If the shear strength of the second adhesive layer is less than about 16 kg/in², detachability is enough that sufficient reworkability can be obtained. However, if the shear strength exceeds about 16 kg/in², the second adhesive layer is not easily peeled off so that sufficient reworkability cannot be obtained. Thus, the shear strength of the second adhesive layer is limited as described above.

According to one embodiment of the present invention, in order to increase selectability, the shear strength may be more narrowly limited to about 0.08 kg/in² to about 10 kg/in² per the test method described above. If the shear strength is less than about 10 kg/in², more excellent reworkability can be obtained. It is preferable that the shear strength of the second adhesive layer is from about 0.08 kg/in² to about 4 kg/in².

According to one embodiment of the present invention, the shear strength of the first adhesive layer is larger than the shear strength of the second adhesive layer.

According to another embodiment of the present invention, in order to increase reworkability, it is possible to adjust the second adhesive layer to have a drop time of 20 seconds or more when 1 kg of weight is applied and a drop time of 600 minutes or less when 3 kg of weight is applied to an area of 4.5 in² at 60° C. It is preferable that the drop time of the second adhesive layer is from 30 seconds or more when a weight of 1 kg is applied, to 300 minutes or less when a weight of 3 kg is applied to an area of 4.5 in² at 60° C.

Drop time is measured as shown in FIG. 9, in which a PMMA/PC plate is adhered to a SUS panel by using the double-sided adhesive tape and a weight of 1 kg or greater is applied to the PMMA/PC plate and measure drop time.

If the second adhesive layer has the drop time described above, it will likely not be peeled off due to external impacts during ordinary use, thereby improving convenience in use, and sufficient reworkability can be obtained.

In order to increase selectability, it is also possible to adjust the second adhesive layer to have a drop time of 30 seconds or more when 1 kg of weight is applied and a drop time of 300 minutes or less when 3 kg of weight is applied to an area of 4.5 in² at 60° C. If the second adhesive layer has the drop time described above, more excellent reworkability can be obtained.

According to one exemplary embodiment of the present invention, the second adhesive layer can be formed of an adhesive polymer. A type or a molecular weight of a polymer forming the second adhesive layer is not limited if the second adhesive layer formed of the polymer has the shear strength or the drop time described above. For example, a polymer having a molecular weight of approximately 10,000 to approximately 300,000 g/mol may be used, or a polymer having a molecular weight beyond the range may be used. The material forming the second adhesive layer, according to necessity, may be an adhesive polymer having a relatively low molecular weight or an adhesive polymer having a relatively high molecular weight. Different materials may be selected according to necessity and choice of a user.

In the case where reworking is required in a manufacturing process using the double-sided adhesive tape of the present invention, if an opposing force is applied to an adhered surface in a parallel direction, the second adhesive layer is peeled off so that the components, which have been attached to one another by means of the double-sided adhesive tape of the present invention, can be easily separated. As a result, reworkability can be increased.

According to one embodiment of the present invention, the film-shaped sheet is made of transparent material, which is selected from a group consisting of an acryl-based resin, a polyester resin, a polycarbonate resin, a norbornene-based resin, an olefin polymer, and TAC (triacetyl cellulose). According to one embodiment of the present invention, polyethylene terephthalate (PET), which is a kind of a polyester resin and has high light transmittance, may be preferably used.

According to one embodiment of the present invention, the thickness of the film-shaped sheet can be adjusted to be approximately 5 μm to approximately 100 μm. If the film-shaped sheet has a thickness in the above range, it can be easily applied to small and large display electronic devices.

According to one embodiment of the present invention, the thickness of the first adhesive layer and the second adhesive layer can be adjusted to be in a range of approximately 5 μm to approximately 500 μm. If the thickness is in the above range, sufficient adhesion to adhere a component to a product, for example, an electronic product, can be obtained.

According to one embodiment of the present invention, the second adhesive layer can be formed of an adhesive polymer composition. The adhesive polymer composition forming the second adhesive layer contains monomers and a polymerization initiator. In addition to the monomers and the polymerization initiator, the adhesive polymer composition may contain at least one of a chain transfer agent, a polymerization retardant, an additive having a low molecular weight of which an average molecular weight is less than about 5000 g/mol, and a curing agent. The contents of the curing agent may vary depending on a type of curing agents used.

According to one embodiment of the present invention, an auxiliary film sheet may be additionally disposed on the surface of the second adhesive layer, opposite the surface on which the film-shaped sheet is disposed. A third adhesive layer is disposed on the auxiliary film sheet. The shear strength of the third adhesive layer is adjusted to be larger than the shear strength of the second adhesive layer.

The double-sided adhesive tape of the present invention is a transparent tape having excellent light transmittance. According to one embodiment of the present invention, the light transmittance of the double-sided adhesive tape is more than about 90%.

The present invention also provides a display device using the double-sided adhesive tape. The display device according to one embodiment of the present invention includes a display panel, a double-sided adhesive tape disposed on the display surface of the display panel, and a transparent plate disposed on the opposite surface of the double-sided adhesive tape. The double-sided adhesive tape is the double-sided adhesive tape having improved reworkability according to the present invention.

According to one embodiment of the present invention, the transparent plate may be a cover window of an electronic device. The transparent plate may be a touch panel. According to one embodiment of the present invention, the transparent plate may be a cover window disposed on the front surface of the touch panel attached onto the display panel.

The double-sided adhesive tape according to the present invention has good wettability with an adherend thereby exhibiting satisfactory adhesion. As such, in the normal use state, there is no need to worry that the double-sided adhesive tape would be peeled off. However, if shear force is applied to an adhered surface in a parallel direction, the second adhesive layer can be easily separated from the adherend. Further, after the separation, adhesive layer material residues can be easily removed. Thus, if the double-sided adhesive tape is used, excellent reworkability can be obtained.

Since the double-sided adhesive tape according to the present invention is transparent, it can be effectively applied to a display surface of a display device. Particularly, the double-sided adhesive tape can be effectively used to adhere and fix transparent plates such as a touch panel or a cover window onto a display surface of a display panel. If a transparent plate is adhered onto a display surface of a display panel by using the double-sided adhesive tape, the second adhesive layer of the double-sided adhesive tape can be easily peeled off so that excellent reworkability can be obtained. Thus, even if a defect occurs in a manufacturing process, it is possible to reuse the configuration component.

### BRIEF DESCRIPTION OF THE DRAWINGS

FIG. 1 is a diagram showing the structure of a double-sided adhesive tape (100) according to one embodiment of the present invention.

FIG. 2 is a diagram showing a transparent plate (310) is attached onto a surface of a display panel (320) using the double-sided adhesive tape (100) of FIG. 1.

FIG. 3 shows that in the double-sided adhesive tape (100) used in FIG. 2, the second adhesive layer is peeled off by applying force to an adhered surface in a parallel direction.

FIG. 4 is a diagram showing a structure of the double-sided adhesive tape (200) according to another embodiment of the present invention.

FIG. 5 is a diagram showing the transparent plate (310) attached onto a surface of the display panel (320) using the double-sided adhesive tape (200) used in FIG. 4.

FIG. 6 shows peeling off the second adhesive layer by applying force to an adhered surface in a parallel direction in the double-sided adhesive tape (200) used in FIG. 5.

FIG. 7 shows a structure to measure shear strength of a double-sided adhesive tape.

FIG. 8 show a stress-strain graph while applying parallel forces to Al strip and SUS panel of FIG. 7 to measures shear strength.

FIG. 9 shows a structure to measure drop time of a double-sided adhesive tape.

### DETAILED DESCRIPTION

The present invention will be described in detail below with reference to the drawings.

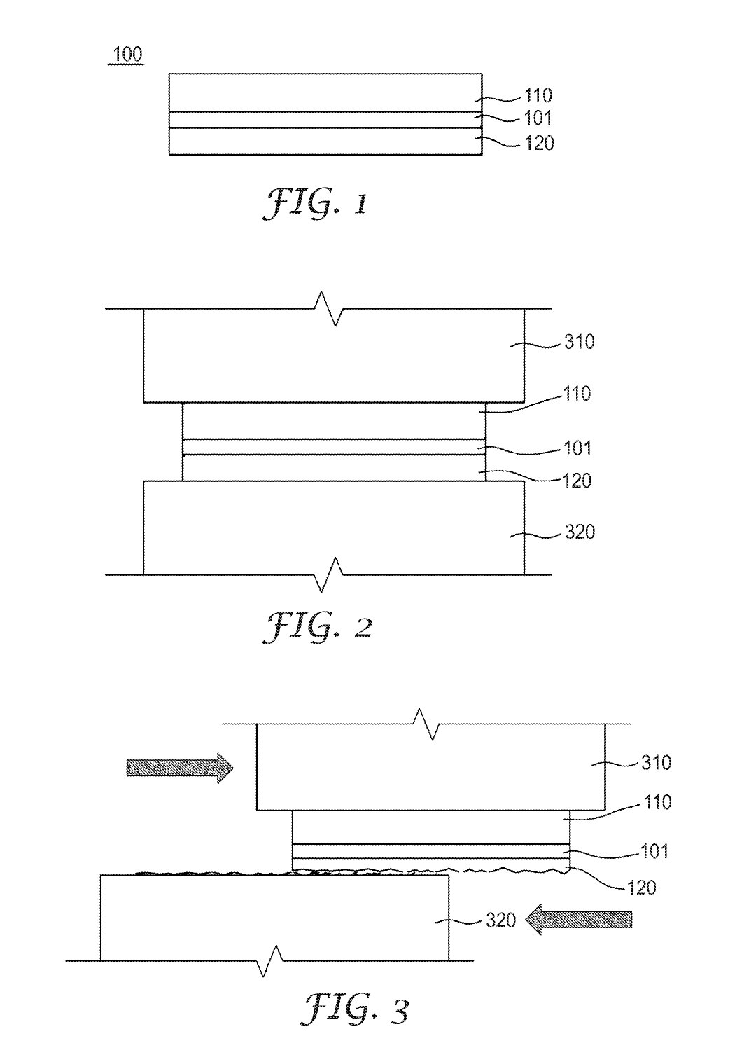

FIG. 1 shows the structure of the double-sided adhesive tape (100) according to one embodiment of the present invention.

The double-sided adhesive tape (100) according to one embodiment of the present invention includes a film-shaped sheet (101), a first adhesive layer (110) disposed on one surface of the sheet, and a second adhesive layer (120) disposed on the other surface of the sheet.

For the film-shaped sheet (101), film-shaped polymer material may be used. Examples of the polymer material include, but are not limited to, an acryl-based resin such as polymethyl methacrylate (PMMA), polyester such as polyethylene terephthalate (PET), polycarbonate, a norbornene-based resin, an olefin polymer, and TAC (triacetyl cellulose), etc. The polymer materials may be used individually or in combination of two or more types thereof.

Among the polymer films, a PET film, which is easily available and has high transparency, may be used.

For the film-shaped sheet (101) according to one embodiment of the present invention, a film-shaped sheet having more than about 90% of light transmittance may be used.

The thickness of the film-shaped sheet (101) is not limited. According to one embodiment of the present invention, the thickness of the film-shaped sheet (101) may be selected in a range of approximately 5 μm to approximately 100 μm. Particularly, the thickness may be in a range of about 10 μm to about 50 μm.

The first adhesive layer is disposed on one surface of the film-shaped sheet (101). According to one embodiment of the present invention, the first adhesive layer (110) can be formed of an adhesive polymer.

For the adhesive polymer forming the first adhesive layer (110), any adhesive polymer may be used if it is commonly used for the attachment of display components and have sufficient transparency to not reduce visibility of a display. Examples of the adhesive polymer include known or generally used pressure-sensitive adhesive polymers, such as acryl-based adhesive polymers, silicon-based adhesive polymers, polyester-based adhesive polymers, rubber-based adhesive polymers, or polyurethane-based adhesive polymers. The adhesive polymers may be used individually or in combination of two or more types thereof. For example, the adhesive polymer forming the first adhesive layer (110) may be an acryl-based polymer which contains C₁₋₁₈ (metha)acrylate having more than 50% by weight based on the total weight of the monomer components.

According to one embodiment of the present invention, the first adhesive layer (110) can be formed of a commercial optical adhesive (e.g., optically clear adhesive) currently available in the market. The first adhesive layer (110) should be transparent with a light transmittance greater than about 90%. Adhesive strength of the first adhesive layer (110) is not limited if the first adhesive layer (110) has sufficient adhesion to stably attach the transparent plate (310) onto the display surface of the display substrate (320).

Although the adhesive polymer forming the first adhesive layer may belong to an identical or a similar kind of adhesive polymer that forms the second adhesive layer, their composition ratios or molecular weights may not be the same.

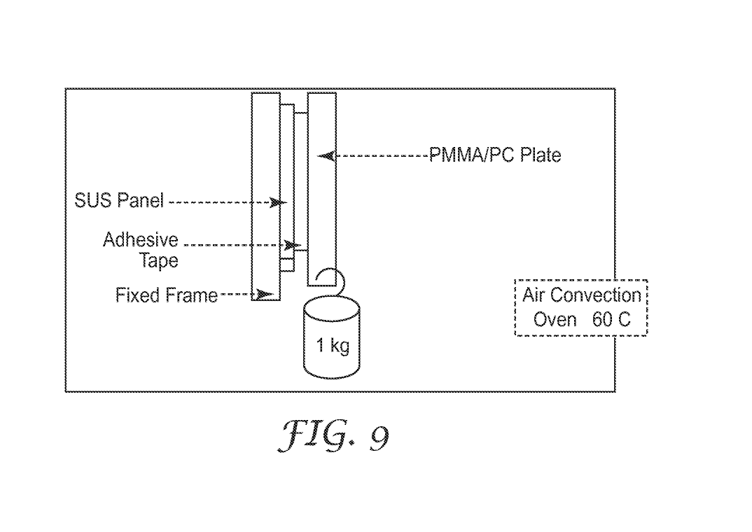

The shear strength of the first adhesive layer may be more than about 1 kg/in². For stronger adhesion, the shear strength of the first adhesive layer may be more than about 3 kg/in². The shear strength is a value measured by conducting an experiment under the condition that an aluminum strip is attached onto a SUS panel using the double-sided adhesive tape as can be seen in FIG. 7. The temperature is 60° C., and the cross-head speed of a tool to peel off the aluminum strip from the SUS panel is 10 mm/min, while opposing force is applied between the aluminum strip and the SUS panel in a parallel direction. During application of the opposing force, stress and strain are measured, as can be seen in FIG. 8, and the maximum stress is regarded as shear strength. (Experimental Condition: Between an Al strip and a SUS panel, and the cross-head speed of 10 mm/min).

A molecular weight of the polymer forming the first adhesive layer is not limited. The molecular weight may be as small as from about 10,000 to as large as about 1,000,000 g/mol, or may be larger than about 1,000,000 g/mol.

The second adhesive layer (120) is formed on the other surface of the film-shaped sheet (101), on which the first adhesive (110) layer is not disposed. The second adhesive layer is a detachable layer, which is easily peeled off when force is applied to an adhered surface in a parallel direction, thereby improving reworkability of a product manufactured by using the double-sided adhesive tape of the present invention.

According to one embodiment of the present invention, the second adhesive layer (120) may be formed of an adhesive polymer. The adhesive polymer forming the second adhesive layer may be prepared by an adhesive polymer composition which comprises monomers and a polymerization initiator and further comprises at least one of a chain transfer agent, a polymerization retardant, an additive having a low molecular weight, and a curing agent.

The adhesive polymer forming the second adhesive layer should have sufficient transparency to not significantly reduce visibility of a display. Examples of the adhesive polymer for the second adhesive layer include known or generally used pressure-sensitive adhesives, such as acryl-based adhesive polymers, silicon-based adhesive polymers, polyester-based adhesive polymers, rubber-based adhesive polymers, and polyurethane-based adhesive polymers. The adhesive polymers may be used individually or in combination of two or more types thereof. Although the adhesive polymer forming the second adhesive layer may be identical or similar in type to the adhesive polymer forming the first adhesive layer, their composition ratios or molecular weights are different.

According to one embodiment of the present invention, an acryl-based adhesive polymer may be used as the adhesive polymer forming the second adhesive layer.

For the acryl-based adhesive polymer, for example, an acryl-based polymer which contains C₁₋₁₈ (meth)acrylic acid alkyl ester, i.e., a C₁₋₁₈ acrylate-based compound as a main component of a monomer, may be used. A copolymer containing one or more monomer(s) different from the C₁₋₁₈ acrylate-based compound may be used.

Examples of the copolymerizable monomer that can be used together with the C₁₋₁₈ acrylate-based monomer include, but are not limited to, a copolymerizable monomer having various functional groups, a styrene-based monomer, an α-olefin-based monomer, vinyl ester, a cyano group containing monomer, an amide group containing monomer, a hydroxilic group containing monomer, an acidic group containing monomer, an epoxy group containing monomer, an amino group containing monomer, and a carboxylic group containing monomer.

Meanwhile, various monomers, which are known as monomers for modification of an acryl-based adhesive polymer, may also be used. According to one embodiment of the present invention, isobornylacrylate known as IBXA may be used.

For a method of preparing the acryl-based adhesive polymer, a known method may be applied. For example, a solution polymerization method, an emulsion polymerization method, a self polymerization method, or a photo polymerization method using a photo initiator may be used.

According to one embodiment of the present invention, a photo polymerization method using a photo initiator as a polymerization initiator may be applied. For the photo polymerization initiator, commercially available Irgacure series may be used.

If necessary, a crosslinking agent may be used. A commercially known crosslinking agent may be used. Particularly, a multi-functional acrylate or methacrylate, a polyfunctional melamine compound, a polyfunctional epoxy compound, a polyfunctional isocyanate compound, or others may be used. However, types of the crosslinking agents are not limited. The crosslinking agents may be used individually or in combination of two or more types thereof.

The adhesive polymer may contain various additives. For example, various known additives such as generally used adhesion-imparting resins, plasticizers, fillers, colorings, ultraviolet absorbing agents, and surfactants can be used. However, even if the additives are added, transparency of the adhesive polymer resin should not be compromised.

In addition, the composition forming the adhesive polymer for the second adhesive layer further contains at least one of a chain transfer agent, a polymerization retardant, an additive having a low molecular weight, and a curing agent.

At least one weak chemical bonding exists in the chain transfer agent to induce chain transfer reaction. Due to the chain transfer reaction, an average molecular weight of a finally produced polymer is reduced. Thus, the chain transfer agent is called a molecular weight controller. In the present invention, the chain transfer agent is used to reduce a molecular weight of the adhesive polymer forming the second adhesive layer (120) so as to adjust the shear strength of the second adhesive layer. According to one embodiment of the present invention, IOTG (isooctyl thioglycolate) may be used as the chain transfer agent.

The polymerization retardant delays a polymerization reaction to reduce a molecular weight of the polymer. According to one embodiment of the present invention, examples of the polymerization retardant include AMS (Alpha-methyl styrene).

The additive having a low molecular weight is added to a polymer composition to reduce adhesive strength or shear strength. An average molecular weight of the additive having a low molecular weight is less than about 5000 g/mol. Even if the additive does not affect the average molecular weight, it enables a portion having a low molecular weight to partially exist in a polymer so as to reduce adhesion or shear strength. As the additive having a low molecular weight, a commercially available product may be used. According to one embodiment of the present invention, as the additive having a low molecular weight, commercial product of Joncyl series (BASF) may be used.

The curing agent is added to a polymer composition to promote or control the curing reaction. The curing agent can basically provide a polymer composition with cohesion and prevent the surface of the second adhesive layer formed by a curing reaction from being damaged. As the curing agent, a commercially available product may be used. According to one embodiment of the present invention, a commercial product of HDD (SK cytec specialties) may be used as the curing agent.

According to the present invention, shear strength of the second adhesive layer has been weakened to improve reworkability of the double-sided adhesive tape. The shear strength can be weakened by the chain transfer agent, the polymerization retardant, and the additive having a low molecular weight. The chain transfer agent, the polymerization retardant, and the additive having a low molecular weight may be used individually or in a mixture of two or more types thereof. According to one embodiment of the present invention, based on 100 parts by weight of monomers, the chain transfer agent may be contained in an amount of about 0.03 to about 5 parts by weight, the polymerization retardant may be contained in an amount of about 0.01 to about 0.5 parts by weight, and the additive having a low molecular weight may be contained in an amount of about 1 to about 50 parts by weight. The component weights may vary depending on the type of monomers used. According to one embodiment of the present invention, the curing agent may be contained in an amount of greater than 0 part by weight, but about 0.07 or less parts by weight, based on 100 parts by weight of monomers.

According to one embodiment of the present invention, shear strength of the second additive layer (120) is smaller than the shear strength of the first adhesive layer (110). As such, in case where reworking is required, if shear force is applied to an adhered surface in a parallel direction, the second adhesive layer is peeled off so that the components adhered to one another by the double-sided adhesive tape of the present invention can be easily separated.

The shear strength of the second adhesive layer (120) is in a range of about 0.05 kg/in² to about 16 kg/in². Specifically, the shear strength is a value measured under the condition that an aluminum strip is attached to a SUS panel, the temperature is 60° C., and the cross-head speed is 10 mm/min (Experimental Condition: Between an Al strip and a SUS panel, and cross-head speed of 10 mm/min).

The shear strength can be adjusted to less than about 16 kg/in² and may vary depending on utilization of the double-sided adhesive tape of the present invention. For example, if the double-sided adhesive tape of the present invention is applied to a mobile device, which is a relatively small device, the shear strength does not need to be as large as the shear strength in the case where the double-sided adhesive tape of the present invention is applied to a large display device. Thus, the shear strength of the double-sided adhesive tape can be adjusted to be less than about 10 kg/in² at a temperature of 60° C., i.e., about 0.08 kg/in² to about 10 kg/in². The mobile device includes generally known devices such as portable phones, smart phones, PMPs, car navigators, MP3 players, tablet PCs, netbooks, and note-type computers.

Meanwhile, in order to facilitate reworkability, the second adhesive layer can be adjusted to have a drop time of 20 seconds or more when 1 kg of weight is applied and a drop time of 600 minutes or less when 3 kg of weight is applied to an area of 4.5 in² at 60° C. using PMMA/PC plate and SUS panel (Experimental Condition: refer to FIG. 9).

The drop time also may vary depending on utilization of the double-sided adhesive tape of the present invention. For example, if the double-sided adhesive tape of the present invention is applied to a mobile device, which is a relatively compact device, the adhesion strength does not need to be as large as the adhesion strength in the case where the double-sided adhesive tape is applied to a large display device. Thus, the double-sided adhesive tape may have a drop time of 30 seconds or more when 1 kg of weight is applied and a drop time of 300 minutes or less when 3 kg of weight is applied to the area of 4.5 in² at 60° C.

As shown in FIG. 2, the second adhesive layer (120) of the double-sided adhesive tape (100) according to one embodiment of the present invention may be applied to attach the transparent plate (310) onto a display surface of the display panel (320). In the case where reworking is required, as shown in FIG. 3, the second adhesive layer (120) should be easily peeled off.

In FIG. 2, the first adhesive layer (110) is attached onto the transparent plate (310), and the second adhesive layer (120) is attached onto a display surface of the display panel (320). In reverse, the first adhesive layer may be attached onto the display surface of the display panel, and the second adhesive layer may be attached onto the transparent plate.

According to one embodiment of the present invention, when forming the second adhesive layer as described above, an adhesive polymer having a relatively low molecular weight may be used to increase reworkability, or an adhesive polymer, which does not have a low average molecular weight but contains an additive having a certain low molecular weight, may be used. In accordance with application utilization and selection by a user, a polymer having a molecular weight of approximately 10,000 to approximately 300,000 g/mol may be used, or a polymer having a molecular weight beyond such range may be used.

According to one embodiment of the present invention, there is provided a method for manufacturing the double-sided adhesive tape of the present invention, wherein the first adhesive polymer prepared in the syrup state is disposed on one surface of the film-shaped sheet (101) and photo cured to form the first adhesive layer (110), and the second adhesive polymer prepared in the syrup state is disposed on the other surface of the film-shaped sheet (101) and photo cured to form the second adhesive layer (120). The sequence of forming the first adhesive layer and the second adhesive layer may be reversed. Simultaneously forming the first adhesive layer and the second adhesive layer is possible.

If necessary, a release paper or a liner may be disposed on the exposed surface of the first adhesive layer and/or the exposed surface of the second adhesive layer.

The thickness of the first adhesive layer (110) and the second adhesive layer (120) are not limited if they can impart sufficient adhesion. For example, both the thickness of the first adhesive layer (110) and the thickness of the second adhesive layer (120) may be approximately 5 μm to approximately 500 μm. Particularly, the thickness may be approximately 100 μm to approximately 400 μm.

The double-sided adhesive tape according to one embodiment of the present invention has more than about 90% of light transmittance (JIS K7361) in a visible spectrum wavelength region.

In the present invention, the double-sided adhesive tape may have an additional layer if the effect of the present invention is not damaged.

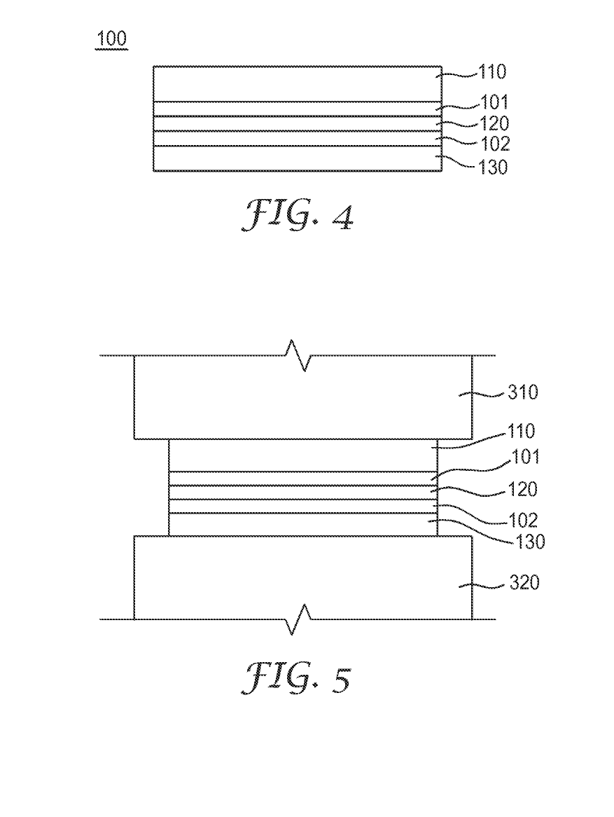

For example, the double-sided adhesive tape (200) illustrated in FIG. 4 has the structure, in which an auxiliary film sheet (102) is disposed on the second adhesive layer (120) of the double-sided adhesive tape of FIG. 1, and a third adhesive layer (130) is disposed on the auxiliary film sheet (102).

The material, thickness, and other aspects of the auxiliary film sheet (102) may be the same as those of the film-shaped sheet (101). The third adhesive layer (130) may be the same as the first adhesive layer (110).

The present invention also provides a display device using the double-sided adhesive tape (100, 200). The display device according to one embodiment of the present invention includes a display panel (320), a double-sided adhesive tape (100, 200) disposed on a display surface of the display panel, and a transparent plate (310) disposed on the double-sided adhesive tape (FIGS. 2 and 5).

Specifically, one embodiment of the present invention illustrated in FIG. 2 relates to the structure, in which the second adhesive layer (120) of the double-sided adhesive tape (100) is adhered onto the display surface of the display panel (320), and the first adhesive layer (130) is adhered onto the transparent plate (310). FIG. 5 shows a structure in which the third adhesive layer (130) of the double-sided adhesive tape (200) according to another embodiment of the present invention is adhered onto the display surface of the display panel (320), and the first adhesive layer (110) is adhered onto the transparent plate (310).

According to one embodiment of the present invention, the transparent plate (310) may be a cover window of an electronic device, or the plate may be a touch panel.

According to another embodiment of the present invention, the transparent plate may be a cover window disposed on the front surface of the touch panel attached onto the display panel. In other words, the double-sided adhesive tape of the present invention may be used even in the case where a cover window is attached onto the front surface of the touch panel.

The double-sided adhesive tape according to the present invention can be attached onto the front display surface of the display panel.

The double-sided adhesive tape (100, 200) according to the present invention can be effectively used to adhere and fix the transparent plate (310) such as a touch panel or a cover window onto the display surface of the display panel (320). The double-sided adhesive tape (100, 200) can also be used even in the case where a cover window is attached onto the front display surface of the touch panel.

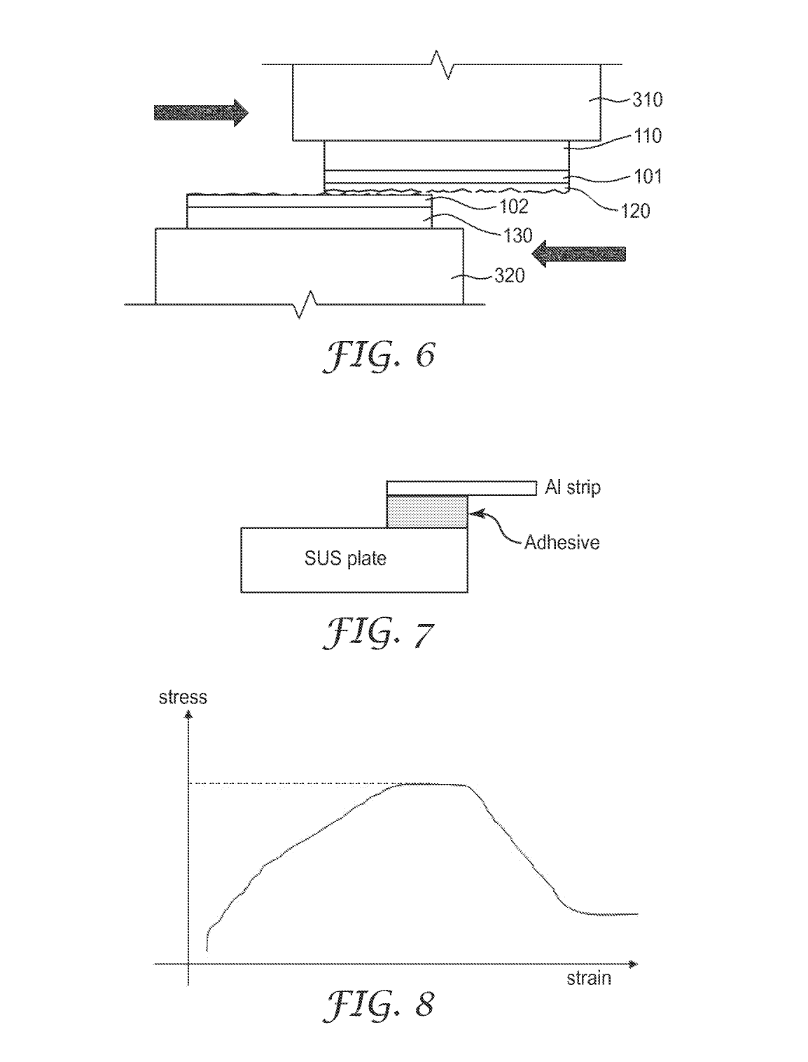

As shown in FIGS. 3 and 6, if a parallel force, i.e. a shear force is applied between transparent plate (310) and display panel (320), the second adhesive layer of the double-sided adhesive tape is easily peeled off so that excellent reworkability can be obtained.

The second adhesive layer (120) of the double-sided adhesive tape (100, 200) according to the present invention has good wettability with an adherend thereby exhibiting satisfactory adhesion. As such, in the normal use state, there is no need to worry that the second adhesive layer (120) would be peeled off. However, if force is applied to an adhered surface in a parallel direction, the second adhesive layer (120) is easily separated. After the separation, adhesive layer material residues can be easily removed. As a result, the separated display panel (320) and transparent plate (310) can be reused and do not need to be discarded. Accordingly, unnecessary waste is reduced so that manufacturing costs can be reduced.

The type of the display panel according to the present invention is not limited. For example, there is a liquid crystal display device, a CRT, a plasma display, an organic light emitting element display, and others.

### EXAMPLES

The present invention will be described more in detail below with reference to Examples and comparative examples.

### Comparative Examples 1 to 4 and Examples 1 to 25

For the film-shaped sheet (101), a PET film having a thickness of 25 μm was used. Optically Clear Adhesive 8146 (commercially available from the 3M Company, St. Paul, Minn.), which is generally used as an OCA (Optically Clear Adhesive), was laminated on one surface of the sheet (101) with a thickness of 100 μm thereby forming the first adhesive layer (110).

In order to provide the second adhesive layer, adhesive polymers of the Comparative Examples and the Examples were prepared in accordance with a photo polymerization method and the composition ratios in Table 1 below. The contents in Table 1 below represent relative weights when a total amount of monomers is 100 parts by weight. For the monomers, a mixture of two types of acryl-based monomers was used.

TABLE 1

| | | | | Chain | | Additive with a | |
|---|---|---|---|---|---|---|---|
| | First | Second | Photo | transfer | Polymerization | low molecular | Curing |
| | monomer | monomer | initiator | agent | retardant | weight | agent |
| Specimen | 2-EHA | IBXA | Irgacure 651 | IOTG | AMS | Joncryl 962 | HDDA |
| Example 1 | 50 | 50 | 0.3 | 0.05 | — | — | — |
| Example 2 | 50 | 50 | 0.3 | 0.1 | — | — | — |
| Example 3 | 50 | 50 | 0.3 | 0.2 | — | — | — |
| Example 4 | 50 | 50 | 0.3 | 0.3 | — | — | — |
| Example 5 | 50 | 50 | 0.3 | 0.4 | — | — | — |
| Example 6 | 50 | 50 | 0.3 | 0.5 | — | — | — |
| Example 7 | 50 | 50 | 0.3 | 1 | — | — | — |
| Example 8 | 45 | 55 | 0.3 | 0.3 | — | — | — |
| Example 9 | 60 | 40 | 0.3 | 0.3 | — | — | — |
| Example 10 | 70 | 30 | 0.3 | 0.3 | — | — | — |
| Example 11 | 50 | 50 | 0.3 | — | 0.2 | — | — |
| Example 12 | 50 | 50 | 0.3 | — | 0.15 | — | — |
| Example 13 | 50 | 50 | 0.3 | — | 0.1 | — | — |
| Example 14 | 50 | 50 | 0.3 | — | 0.05 | — | — |
| Example 15 | 50 | 50 | 0.3 | — | — | 5 | — |
| Example 16 | 50 | 50 | 0.3 | — | — | 10 | — |
| Example 17 | 50 | 50 | 0.3 | — | — | 15 | — |
| Example 18 | 50 | 50 | 0.3 | — | — | 20 | — |
| Example 19 | 50 | 50 | 0.3 | 0 | — | — | — |
| Example 20 | 50 | 50 | 0.3 | 0.02 | — | — | — |
| Example 21 | 60 | 40 | 0.3 | — | — | — | — |
| Example 22 | 60 | 40 | 0.15 | — | — | — | — |
| Example 23 | 60 | 40 | 0.15 | — | — | — | 0.02 |
| Example 24 | 60 | 40 | 0.15 | — | — | — | 0.05 |
| Example 25 | 60 | 40 | 0.15 | — | — | — | 0.07 |
| Comparative | 60 | 40 | 0.15 | — | — | — | 0.1 |
| Example 1 | | | | | | | |
| Comparative | 60 | 40 | 0.15 | — | — | — | 0.12 |
| Example 2 | | | | | | | |
| Comparative | 60 | 40 | 0.15 | — | — | — | 0.15 |
| Example 3 | | | | | | | |
| Comparative | 60 | 40 | 0.15 | — | — | — | 0.20 |
| Example 4 | | | | | | | |

Material information for the above is shown in Table 2 below.

TABLE 2

| Trade | | | | |
|---|---|---|---|---|
| name | Type | Grade | Supplier | Remarks |
| 2-EHA | Monomer | — | LG Chemical | 2-ethlyhexyl acrylate |
| IBXA | Monomer | — | Osaka Organic | Isobornyl arcrylate |
| | | | Chemical | |
| Irgacure | Photo | — | BASF | 2,2-Dimethoxy-1,2- |
| 651 | initiator | | | diphenylethan-1-one |
| IOTG | Chain | Pure | TCI (Tokyo | Isooctyl thioglycolate |
| | transfer | | chemical | |
| | agent | | Industry) | |
| AMS | Monomer | Pure | Sigma Aldrich | Alpha methly styrene |
| Joncryl | Acryl polyol | | BASF | — |
| 963 | | | | |
| HDDA | Curing agent | — | SK Cytec | Hexandiol diacrylate |
| | | | specialties | |

A monomer mixture including a photo initiator was partially polymerized under nitrogen-rich atmosphere by exposure to UV radiation as Table 3 below, and as a result a syrup state pre-polymerized preparation was obtained.

TABLE 3

| UVA | | | |
|---|---|---|---|
| Intensity | N₂ Purging time | Delta T | Final Viscosity |
| 0.3 mW/cm² | 15 min | 6° C. | 1000-2000 cps |

After addition of other additives remained, the above obtained syrup state pre-polymerized preparation was knife coated between two silicone coated PET liners.

The coated material was exposed to low intensity UV radiation passing through four separate zones, as shown in Table 4 below, to obtain a second adhesive layer (120) with a thickness of 50 μm.

TABLE 4

| | Zone 1 | Zone 2 | Zone 3 | Zone 4 |
|---|---|---|---|---|
| Intensity | 3.0 | 5.0 | 6.0 | 6.0 |
| (mW/cm²) | | | | |
| Residence time(s) | 45 | 45 | 45 | 45 |

The above prepared second adhesive layer was coated on the other surface of the film-shaped sheet (101) to manufacture the double-sided adhesive tape and referred to as Comparative Examples 1 to 4 and Examples 1 to 25, respectively.

### Evaluation

Molecular weights of the adhesive polymer used to prepare the double-sided adhesive tapes of Comparative Examples 1 to 4 and Examples 1 to 25 were measured, and the drop time and shear strength of the double-sided adhesive tapes were measured at a temperature of 60° C.

Shear strength was measured under the experimental condition of between an Al strip and a SUS panel and with a cross-head speed of 10 mm/min.

In detail, the double-sided adhesive tape sample was prepared in a size of 1″×1″ for 60° C. shear test.

As shown in FIG. 7, the sample was laminated on Al strip with second adhesive layer (120; low cohesive side) facing Al strip, in which the Al strip has a thickness of 1.3 mm and a width of 28 mm, and the other side of the sample was laminated to SUS panel (SUS: 0.8 mm×75 mm×75 mm) with the first adhesive layer (110) facing SUS panel. SUS panel is a stainless panel.

The laminated sample was auto claved under 60° C. 1 Mpa, for 20 minutes.

The sample was put into an air convection chamber (provided by Instron) at 60° C. and an opposing force was applied between the aluminum strip and the SUS panel in a parallel direction with a cross head speed of 10 mm/min. A stress-strain curve was measured for 10 minutes as shown in FIG. 8, and maximum stress was taken as shear strength.

Drop time was measured at 60° C. as shown in FIG. 9.

In detail, the double-sided adhesive tape sample was prepared at a size of 47 mm×62 mm, which is 4.5 inch. The above sample was laminated onto a PMMA/PC plate with the second adhesive layer (120; low cohesive side) facing the PMMA/PC plate. The PMMA/PC plate is Luplion® MR58 from MGC filsheet Co., Ltd, and its size is 52 mm×70 mm×0.8 mm (thickness). The sample was also laminated to SUS panel (SUS: 0.8 mm×75 mm×75 mm) with the first adhesive layer (110) facing SUS panel.

The laminated sample was put into an auto clave under 60° C., 1 Mpa for 20 minutes, then put into an air convection oven at 60° C. with a 1 kg weight or a 3 kg weight applied to the PMMA/PC plate, respectively. Afterward, the drop time was measured. In the event the second adhesive layer was not peeled off and separated by applying the 1 kg weight, the 3 kg weight was applied to measure the drop time. Tables 5 and 6 show the results.

TABLE 5

| | Drop Time (min) | Shear |
|---|---|---|
| | (when a weight of 1 Kg is applied) | Strength (kgf/in²) |
| Example 1 | 90 | 2 |
| Example 2 | 35 | 1.5 |
| Example 3 | 19 | 0.9 |
| Example 4 | 13 | 0.7 |
| Example 5 | 9 | 0.8 |
| Example 6 | 8 | 0.5 |
| Example 7 | 4 | 0.3 |
| Example 8 | 21.5 | 1.2 |
| Example 9 | 1.5 | 0.25 |
| Example 10 | 0.5 | 0.08 |
| Example 11 | 28.1 | 1.3 |
| Example 12 | 34.7 | 1.3 |
| Example 13 | 47.5 | 1.6 |
| Example 14 | 80.9 | 1.8 |
| Example 15 | 46.7 | 1.6 |
| Example 16 | 15 | 1 |
| Example 17 | 10.9 | 0.8 |
| Example 18 | 3 | 0.4 |
| Example 19 | 377 | 3 |
| Example 20 | 220 | 2.5 |
| Example 21 | 306 | 2.1 |

TABLE 6

| | | | Shear |
|---|---|---|---|
| | | | Strength |
| | Drop Time (min) | | (kgf/in²) |
| Example 22 | 808 (1 kgf) | 38.6 (3 kgf) | 2.6 |
| Example 23 | 1420 (1 kgf) | 49.7 (3 kgf) | 3.1 |
| Example 24 | Not separated (1 kgf) | 228 (3 kgf) | 11.1 |
| Example 25 | Not separated (1 kgf) | 520.5 (3 kgf) | 15.4 |
| Comparative | Not separated (1 kgf) | Not separated (3 kgf) | 18.9 |
| Example 1 | | | |
| Comparative | Not separated (1 kgf) | Not separated (3 kgf) | 20.2 |
| Example 2 | | | |
| Comparative | Not separated (1 kgf) | Not separated (3 kgf) | 19.9 |
| Example 3 | | | |
| Comparative | Not separated (1 kgf) | Not separated (3 kgf) | 19.3 |
| Example 4 | | | |

As shown in Tables 5 and 6 above, if at least one of a chain transfer agent, a polymerization retardant, an additive having a low molecular weight, and a curing agent is contained in an appropriate amount, the shear strength of the second adhesive layer (120) is lowered and the drop time is reduced so that when force is applied to an adhered surface in a parallel direction, the second adhesive layer can be easily peeled off and separated.

In particular, when forcibly separating the PMMA/PC plate and the second adhesive layer, the double-sided adhesive tapes of Examples 1 to 25 showed a cohesion failure, i.e., the PMMA/PC plate and the second adhesive layer are separated while maintaining their original structures. On the other hand, the double-sided adhesive tapes of Comparative Examples 1 to 4 showed an adhesion failure, in which the PMMA/PC plate and the second adhesive layer separated causing damage to each other.

Therefore, the present invention provides an adhesive tape, which is capable of safely attaching electronic device components to one another, and if necessary, can be easily peeled off thereby improving reworkability.

1. A double-sided adhesive tape comprising:
a film-shaped sheet;
a first adhesive layer disposed on one surface of the sheet; and
a second adhesive layer disposed on the other surface of the sheet;
wherein shear strength of the second adhesive layer is from about 0.05 kg/in² to about 16 kg/in² under the condition that temperature is 60° C., an aluminum strip and a SUS panel are used, and the cross-head speed is 10 mm/min.

2. The double-sided adhesive tape according to claim 1, wherein the shear strength of the first adhesive layer is the same as or larger than the shear strength of the second adhesive layer.

3. The double-sided adhesive tape according to claim 1, wherein the shear strength is less than about 1 kg/in² under the condition that the temperature is 60° C., an aluminum strip and a SUS panel are used, and the cross-head speed is 10 mm/min.

4. The double-sided adhesive tape according to claim 1, wherein drop time of the second adhesive layer ranges from 20 seconds or more when 1 kg of weight is applied, to 600 minutes or less when 3 kg of weight is applied to an area of 4.5 in² at 60° C. using PMMA/PC plate and SUS panel.

5. The double-sided adhesive tape according to claim 1, wherein the drop time of the second adhesive layer ranges from 30 seconds or more when 1 kg of weight is applied, to 300 minutes or less when 3 kg of weight is applied to an area of 4.5 in² at 60° C. using PMMA/PC plate and SUS panel.

6. The double-sided adhesive tape according to claim 1, wherein the film-shaped sheet is selected from a group consisting of an acryl-based resin, a polyester resin, a polycarbonate resin, a norbornene-based resin, an olefin polymer, and TAC (triacetyl cellulose).

7. The double-sided adhesive tape according to claim 1, wherein the film-shaped sheet is polyethylene terephthalate (PET).

8. The double-sided adhesive tape according to claim 1, wherein thickness of the film-shaped sheet is approximately 5 μm to approximately 100 μm.

9. The double-sided adhesive tape according to claim 1, wherein light transmittance of the film-shaped sheet is more than 90%.

10. The double-sided adhesive tape according to claim 1, wherein the thickness of each of the first adhesive layer and the second adhesive layer is in a range of approximately 5 μm to approximately 500 μm.

11. The double-sided adhesive tape according to claim 1, wherein the second adhesive layer is formed of an adhesive polymer composition, and
the adhesive polymer composition contains monomers, a polymerization initiator, and at least one of a chain transfer agent, a polymerization retardant, an additive having a low molecular weight, and a curing agent.

12. The double-sided adhesive tape according to claim 11, wherein based on 100 parts by weight of monomers, at least one of about 0.03 to about 5 parts by weight of the chain transfer agent, about 0.01 to about 0.5 parts by weight of the polymerization retardant, and about 1 to about 50 parts by weight of the additive having a low molecular weight is contained.

13. The double-sided adhesive tape according to claim 1, wherein an auxiliary film sheet is additionally disposed on the surface of the second adhesive layer, opposite the surface, on which the film-shaped sheet is disposed, and a third adhesive layer is disposed on the auxiliary film sheet.

14. The double-sided adhesive tape according to claim 1, wherein the shear strength of the third adhesive layer is larger than the shear strength of the second adhesive layer.

15. The double-sided adhesive tape according to claim 1, wherein the light transmittance is more than 90%.

16. A display device comprising:
a display panel,
a double-sided adhesive tape disposed on a display surface of the display panel, and
a transparent plate disposed on the double-sided adhesive tape,
wherein the double-sided adhesive tape is the double-sided adhesive tape according to claim 1.

17. The display device according to claim 16, wherein the transparent plate is a cover window of an electronic device.

18. The display device according to claim 16, wherein the transparent plate is a touch panel.
